(19) United States
(12) Patent Application Publication
(10) Pub. No.: US 2016/0043853 A1
(43) Pub. Date: Feb. 11, 2016

(54) Device and Method of Handling Device-to-Device Communication

(71) Applicant: HTC Corporation, Taoyuan City (TW)

(72) Inventor: Li-Cheng Lin, Taoyuan City (TW)

(21) Appl. No.: 14/810,497

(22) Filed: Jul. 28, 2015

Related U.S. Application Data
(60) Provisional application No. 62/034,172, filed on Aug. 7, 2014.

(51) Int. Cl. H04L 5/00; H04W 72/04; H04W 76/02

(52) U.S. Cl. CPC H04L 5/0055; H04W 76/023; H04L 5/0048; H04W 72/0413

(57) ABSTRACT

A communication device for handling a device-to-device (D2D) communication comprises a storage unit for storing instructions and a processing means coupled to the storage unit. The processing means is configured to execute the instructions stored in the storage unit. The instructions comprises receiving a D2D grant from a network in a first subframe; and transmitting an acknowledgement in response to the D2D grant to the network in a second subframe.

### CROSS REFERENCE TO RELATED APPLICATIONS

This application claims the benefit of U.S. Provisional Application No. 62/034,172, filed on Aug. 7, 2014 and incorporated herein by reference.

### BACKGROUND OF THE INVENTION

1. Field of the Invention

The present invention is related to a communication device and a method used in a wireless communication system, and more particularly, to a communication device and a method of handling a device-to-device communication in a wireless communication system.

2. Description of the Prior Art

A long-term evolution (LTE) system supporting the 3rd Generation Partnership Project (3GPP) Rel-8 standard and/or the 3GPP Rel-9 standard are developed by the 3GPP as a successor of the universal mobile telecommunication system (UMTS) for further enhancing performance of the UMTS to satisfy increasing needs of users. The LTE system includes a new radio interface and a new radio network architecture that provides high data rate, low latency, packet optimization, and improved system capacity and coverage. In the LTE system, a radio access network known as an evolved universal terrestrial radio access network (E-UTRAN) includes multiple evolved Node-Bs (eNBs) for communicating with multiple user equipments (UEs), and for communicating with a core network including a mobility management entity (MME), a serving gateway, etc., for Non-Access Stratum (NAS) control.

A LTE-advanced (LTE-A) system, as its name implies, is an evolution of the LTE system. The LTE-A system targets faster switching between power states, improves performance at the coverage edge of an eNB, and includes advanced techniques, such as carrier aggregation (CA), coordinated multipoint (COMP) transmissions/reception, uplink (UL) multiple-input multiple-output (UL-MIMO), etc. For a UE and an eNB to communicate with each other in the LTE-A system, the UE and the eNB must support standards developed for the LTE-A system, such as the 3GPP Rel-10 standard or later versions.

Device-to-device (D2D) communication may be realized, after an initialization (e.g., connection establishment and/or peer discovery) is performed (e.g., assisted by an eNB). Then, two UEs may communicate (e.g., transmitting and/or receiving packets) with each other (e.g., directly) according to the D2D communication, and the eNB may not need to forward the packets transmitted between the UEs. According to the D2D communication, the UEs may communicate with each other via UL resources (e.g., UL subframes configured by the eNB). In general, the D2D communication may also be seen as a D2D service (i.e., proximity-based service (ProSe)). The D2D service can be a ProSe direct discovery or a ProSe direct communication. In addition, a D2D subframe, D2D transmission, D2D communication and D2D discovery can be termed as a sidelink subframe, sidelink transmission, sidelink communication and sidelink discovery, respectively.

However, a UE does not acknowledge a reception of a D2D grant transmitted by an eNB according to the 3GPP standards. Accordingly, the eNB does not know whether the D2D grant is received correctly. A resource indicated (e.g., assigned) by the D2D grant is wasted, if the UE does not receive the D2D grant correctly, e.g., the D2D grant is missed. Neither the D2D grant is transmitted again, nor the resource is (re)assigned to another UE. Performance of the D2D communication is greatly reduced due to the unreliable transmission/reception of the D2D grant.

Thus, it is important to solve the problem of the reception/transmission of the D2D grant.

### SUMMARY OF THE INVENTION

The present invention therefore provides a communication device and a method for handling a device-to-device communication to solve the abovementioned problem.

A communication device for handling a device-to-device (D2D) communication comprises a storage unit for storing instructions and a processing means coupled to the storage unit. The processing means is configured to execute the instructions stored in the storage unit. The instructions comprises receiving a D2D grant from a network in a first subframe; and transmitting an acknowledgement in response to the D2D grant to the network in a second subframe.

A communication device for handling a device-to-device (D2D) communication comprises a storage unit for storing instructions and a processing means coupled to the storage unit. The processing means is configured to execute the instructions stored in the storage unit. The instructions comprises receiving at least one of a first physical downlink (DL) shared channel (PDSCH) indicated by a first physical DL control channel (PDCCH) or enhanced PDCCH (ePDCCH), a second PDCCH or ePDCCH indicating a DL semi-persistent scheduling (SPS) release, a second PDSCH indicated by a SPS and a D2D grant in a first subframe; and transmitting at least one acknowledgement in response to a set of the at least one of the first PDSCH, the second PDCCH or ePDCCH, the second PDSCH and the D2D grant to the network in a second subframe according to at least one priority of the set of the at least one of the first PDSCH, the second PDCCH or ePDCCH, the second PDSCH and the D2D grant.

A communication device for handling a device-to-device (D2D) communication comprises a storage unit for storing instructions and a processing means coupled to the storage unit. The processing means is configured to execute the instructions stored in the storage unit. The instructions comprises stopping to transmit a D2D grant to a D2D device in a subframe, if one of a first physical downlink (DL) shared channel (PDSCH) indicated by a first physical DL control channel (PDCCH) or enhanced PDCCH (ePDCCH), a second PDCCH or ePDCCH indicating a DL semi-persistent scheduling (SPS) release and a second PDSCH indicated by a SPS is scheduled to be transmitted to the D2D device in the subframe.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an example of the present invention.

FIG. 2 is a schematic diagram of a communication device according to an example of the present invention.

FIG. 3 is a flowchart of a process according to an example of the present invention.

FIG. 4 is a flowchart of a process according to an example of the present invention.

FIG. 5 is a flowchart of a process according to an example of the present invention.

### DETAILED DESCRIPTION

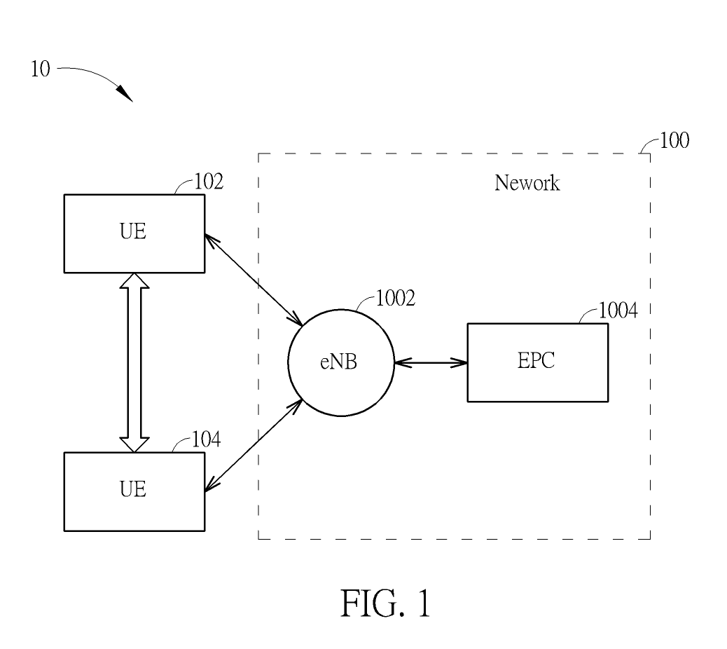

FIG. 1 is a schematic diagram of a wireless communication system 10 according to an example of the present invention. The wireless communication system 10 is briefly composed of a network 100 and user equipments (UEs) 102 and 104. In FIG. 1, the network 100 and the UEs 102 and 104 are simply utilized for illustrating the structure of the wireless communication system 10. A UE may communicate with the network 100 according to a device-to-cellular (D2C) communication (i.e., device-to-network (D2N) communication) defined in a communication standard, e.g., the 3rd Generation Partnership Project (3GPP) standard. Practically, the network 100 may be a universal terrestrial radio access network (UTRAN) comprising at least one Node-B (NB) in a universal mobile telecommunications system (UMTS). In another example, the network 100 may be an evolved UTRAN (E-UTRAN) comprising at least one evolved NB (eNB) and/or at least one relay station in a long term evolution (LTE) system, a LTE-Advanced (LTE-A) system or an evolution of the LTE-A system. As an example, the network 100 includes an eNB 1002 connected to an evolved packet core (EPC) 1004 in FIG. 1.

Furthermore, the network 100 may also include both the UTRAN/E-UTRAN and a core network, wherein the core network includes network entities such as Mobility Management Entity (MME), Serving Gateway (S-GW), Packet Data Network (PDN) Gateway (P-GW), Self-Organizing Networks (SON) server and/or Radio Network Controller (RNC), etc. In other words, after the network 100 receives information transmitted by a UE (e.g., the UE 102 and/or the UE 104), the information may be processed only by the UTRAN/E-UTRAN and decisions corresponding to the information are made at the UTRAN/E-UTRAN. Alternatively, the UTRAN/E-UTRAN may forward the information to the core network, and the decisions corresponding to the information are made at the core network after the core network processes the information. In addition, the information may be processed by both the UTRAN/E-UTRAN and the core network, and the decisions are made after coordination and/or cooperation are performed by the UTRAN/E-UTRAN and the core network.

A UE (e.g., the UE 102 and/or the UE 104) may be a low cost device (e.g., machine type communication (MTC) device), a device-to-device (D2D) device, a mobile phone, a laptop, a tablet computer, an electronic book, a portable computer system, or combination thereof. In addition, for the D2C communication, the network 100 and the UE may be seen as a transmitter or a receiver according to direction (i.e., transmission direction), e.g., for an uplink (UL), the UE is the transmitter and the network 100 is the receiver, and for a downlink (DL), the network 100 is the transmitter and the UE is the receiver.

In addition, the UEs 102 and 104 may communicate with each other directly, after an initialization (e.g., connection establishment and/or peer discovery) is performed. For example, the initialization may be assisted by the network 100. That is, the UEs 102 and 104 may communicate (e.g., transmit and/or receive signals/packets) with each other according to a D2D communication defined in a communication standard, e.g., 3GPP standard. The UEs 102 and 104 may communicate with each other via UL resources (e.g., UL subframes or UL carriers) determined according to frequency-division duplexing (FDD) configuration(s) and/or time-division duplexing (TDD) configuration(s).

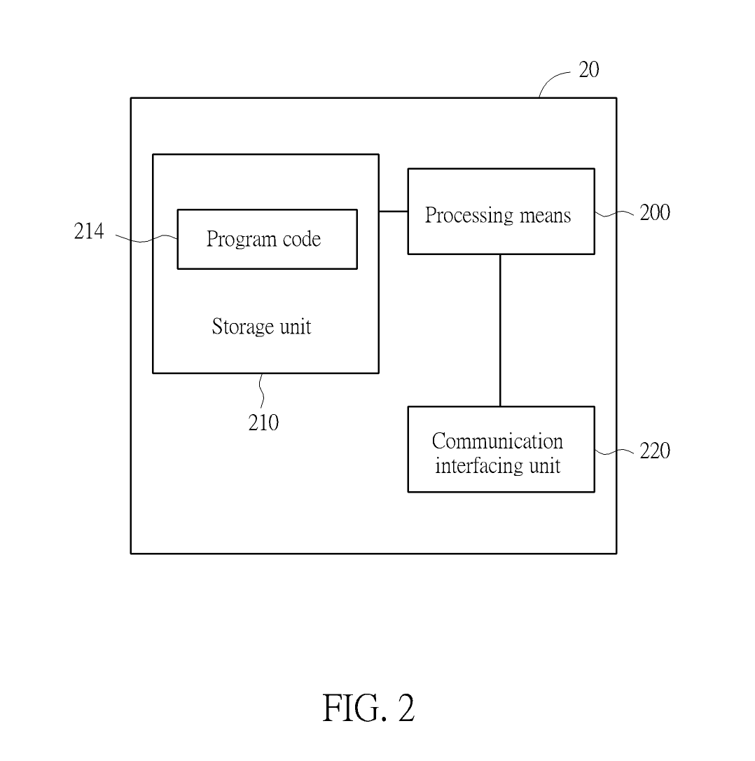

FIG. 2 is a schematic diagram of a communication device 20 according to an example of the present invention. The communication device 20 may be used for realizing the network 100 (e.g., the eNB 1002 and/or the EPC 1004), the UE 102 and/or the UE 104 shown in FIG. 1, but is not limited herein. The communication device 20 may include a processing means 200 such as a microprocessor or Application Specific Integrated Circuit (ASIC), a storage unit 210 and a communication interfacing unit 220. The storage unit 210 may be any data storage device that may store a program code 214, accessed and executed by the processing means 200. Examples of the storage unit 210 include but are not limited to a subscriber identity module (SIM), read-only memory (ROM), flash memory, random-access memory (RAM), Compact Disc Read-Only Memory (CD-ROM), digital versatile disc-ROM (DVD-ROM), Blu-ray Disc-ROM (BD-ROM), magnetic tape, hard disk, optical data storage device, non-volatile storage unit, non-transitory computer-readable medium (e.g., tangible media), etc. The communication interfacing unit 220 is preferably a transceiver and is used to transmit and receive signals (e.g., data, signals, messages and/or packets) according to processing results of the processing means 200.

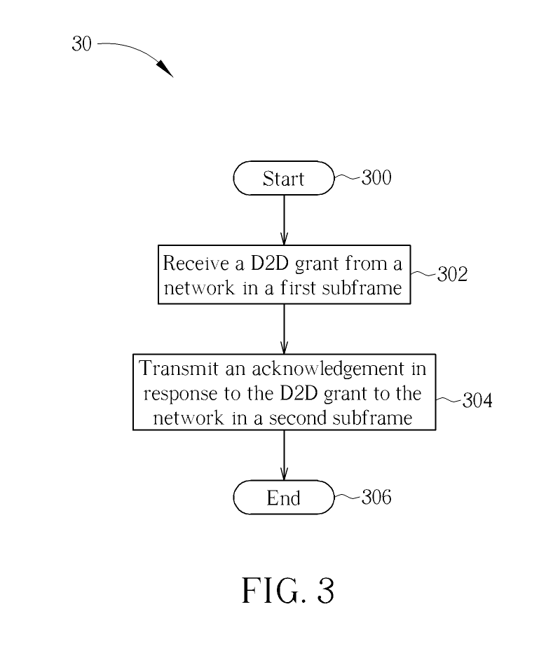

FIG. 3 is a flowchart of a process 30 according to an example of the present invention. The process 30 may be utilized in a UE (e.g., the UE 102 or the UE 104) shown in FIG. 1, to handle a D2D communication. The UE may be a D2D transmitter. The process 30 may be compiled into the program code 214 and includes the following steps:
Step 300: Start.
Step 302: Receive a D2D grant from a network in a first subframe.
Step 304: Transmit an acknowledgement in response to the D2D grant to the network in a second subframe.
Step 306: End.

According to the process 30, the UE may receive a D2D grant from a network (e.g., the network 100) in a first subframe, and may transmit an acknowledgement in response to the D2D grant to the network in a second subframe. That is, the D2D grant is acknowledged such that the network knows whether the D2D grant is received correctly or not and the network may perform a proper operation according to the acknowledgement. For example, the network may retransmit the D2D grant, if the acknowledgement indicates that the D2D grant is not received correctly. In another example, the network may perform successive operation(s), if the acknowledgement indicates that the D2D grant is received correctly. Thus, performance of the D2D communication can be improved due to correct knowledge regarding the reception of the D2D grant.

Realization of the present invention is not limited to the above description.

A method according to which the second subframe in the process 30 is determined is not limited. In one example, the second subframe may be determined according to a TDD configuration (e.g., UL/DL configuration) of the UE. In one example, a time difference between the first subframe and the second subframe maybe a fixed value. That is, the first subframe maybe the subframe n, and the second subframe may be the subframe (n+k), where k is a positive and fixed integer.

The acknowledgement in the process 30 may be transmitted in various ways. In one example, the acknowledgement maybe transmitted on a physical UL control channel (PUCCH) of the second subframe. Further, the acknowledgement may be transmitted on the PUCCH, if a data transmission is not performed on a physical UL shared channel (PUSCH) of the second subframe. That is, a condition may be used for determining whether the acknowledgement is transmitted on the PUCCH or the PUSCH. Examples of transmitting the acknowledgement on the PUCCH are illustrated as follows. In one example, a PUCCH resource for transmitting the acknowledgement may be determined according to a control channel element (CCE) of a DL control channel for transmitting the D2D grant. That is, the PUCCH resource may be determined dynamically. The DL control channel may be a physical DL control channel (PDCCH) or an enhanced PDCCH (ePDCCH). The UE may use n_{PUCCH}^{(1,\tilde{p}}^{₀}⁾=n_{CCE}+N_{PUCCH}⁽¹⁾ for an antenna port p₀, where n_{CCE} is the number of the first CCE (i.e., lowest CCE index used to construct the PDCCH) used for a transmission of a corresponding DL control information (DCI) assignment and N_{PUCCH}⁽¹⁾ may be configured by a higher layer signaling. For a case of two antenna port transmission, a PUCCH resource for an antenna port p₁ may be obtained according to n_{PUCCH}^{(1,\tilde{p}}^{₁}⁾=n_{CCE}+N_{PUCCH}⁽¹⁾. In another example, a PUCCH resource for transmitting the acknowledgement may be determined according to at least one of a higher layer signaling and the D2D grant. A set of PUCCH resources may be first allocated to the UE, e.g., by the higher layer signaling, and then content of the D2D grant may be used for determining n_{PUCCH}^{(1,\tilde{p}}^{₀}⁾ for an antenna port p₀. For a case of two antenna port transmission, n_{PUCCH}^{(1,\tilde{p}}^{₁}⁾ for an antenna port p₁ may also be determined in similarly. In another example, the PUCCH resource may be determined according to a higher layer signaling. That is, the PUCCH resource may be determined statically. An antenna port p₀ may be explicitly indicated by the higher layer signaling. For a case of two antenna port transmission, n_{PUCCH}^{(1,\tilde{p}}^{₁}⁾ for antenna port p₁ may be also explicitly indicated by the higher layer signaling.

The acknowledgement in the process 30 may be transmitted on a PUSCH of the second subframe. Further, the acknowledgement may be transmitted on the PUSCH, if a data transmission is performed on the PUSCH. That is, the acknowledgement maybe transmitted with the data on the PUSCH.

The D2D grant in the process 30 may be acknowledged with acknowledgement(s) of D2C transmission(s). In one example, the UE may further transmit another acknowledgement in response to a PDSCH (e.g., D2C reception) to the network in the second subframe. That is, the D2D grant and the PDSCH may be acknowledged in the same subframe. Further, the PDSCH may be indicated by a PDCCH, or may be indicated by an ePDCCH. In another example, the PDSCH may be indicated by a semi-persistent scheduling (SPS). In one example, the UE may further transmit another acknowledgement in response to a PDCCH (or ePDCCH) (e.g., D2C reception) to the network in the second subframe, wherein the PDCCH (or ePDCCH) indicates a DL SPS release. That is, the D2D grant and the PDCCH (or ePDCCH) may be acknowledged in the same subframe. According to the above examples, the UE can acknowledge a D2D reception (e.g., D2D grant) and D2C reception(s) (e.g., PDSCH and/or PDCCH (or ePDCCH)) in a same subframe. Thus, the performance of the D2D communication and the D2C communication are both improved.

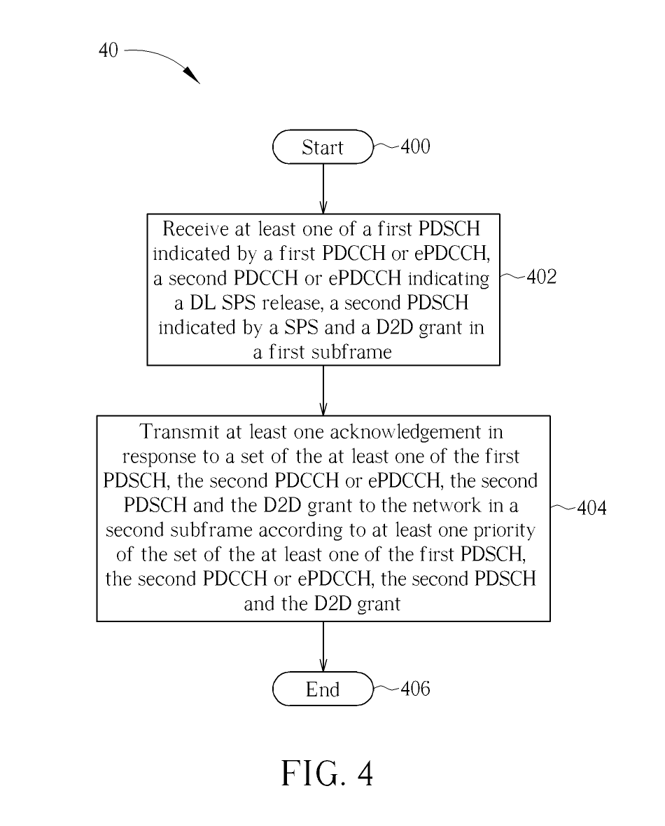

FIG. 4 is a flowchart of a process 40 according to an example of the present invention. The process 40 maybe utilized in a UE (e.g., the UE 102 or the UE 104) shown in FIG. 1, to handle a D2D communication. The UE may be a D2D transmitter. The process 40 may be compiled into the program code 214 and includes the following steps:
Step 400: Start.
Step 402: Receive at least one of a first PDSCH indicated by a first PDCCH or ePDCCH, a second PDCCH or ePDCCH indicating a DL SPS release, a second PDSCH indicated by a SPS and a D2D grant in a first subframe.
Step 404: Transmit at least one acknowledgement in response to a set of the at least one of the first PDSCH, the second PDCCH or ePDCCH, the second PDSCH and the D2D grant to the network in a second subframe according to at least one priority of the set of the at least one of the first PDSCH, the second PDCCH or ePDCCH, the second PDSCH and the D2D grant.
Step 406: End.

According to the process 40, the UE may receive at least one of a first PDSCH indicated by a first PDCCH or ePDCCH, a second PDCCH or ePDCCH indicating a DL SPS release, a second PDSCH indicated by a SPS and a D2D grant in a first subframe. Then, the UE may transmit at least one acknowledgement in response to a set of the at least one of the first PDSCH, the second PDCCH or ePDCCH, the second PDSCH and the D2D grant to the network in a second subframe according to at least one priority of the set of the at least one of the first PDSCH, the second PDCCH or ePDCCH, the second PDSCH and the D2D grant. That is, the UE may respond to only a subset of the received signals according to the priorities of the received signals, if a resource in the second subframe is only sufficient for transmitting the acknowledgement(s) of the subset of the received signals. Thus, the signals (e.g., control signals) received in the same subframe can be acknowledged properly (e.g., completely), when the resource is not sufficient for responding to all of the signals received in the same subframe.

Realization of the present invention is not limited to the above description.

Priorities of the signals that may be received in the first subframe are not limited. For example, a plurality of priorities of the at least one of the first PDSCH, the second PDCCH (or ePDCCH), the second PDSCH and the D2D grant from high to low may be the priority of the first PDSCH, the priority of the second PDCCH (or ePDCCH), the priority of the second PDSCH and the priority of the D2D grant. In one example, the UE may receive the first PDSCH and the D2D grant in the first subframe. Because the priority of the first PDSCH is higher than the priority of the D2D grant, the UE may transmit only the acknowledgement of the first PDSCH in the second subframe if the resource in the second subframe is not for transmitting both the acknowledgements of the first PDSCH and the D2D grant. In another example, the UE may receive the first PDSCH, the second PDCCH (or ePDCCH) and the D2D grant in the first subframe. The UE may transmit only the acknowledgements of the first PDSCH and the second PDCCH (or ePDCCH) in the second subframe, if the resource in the second subframe is not for transmitting all of the acknowledgements of the first PDSCH, the second PDCCH (or ePDCCH) and the D2D grant.

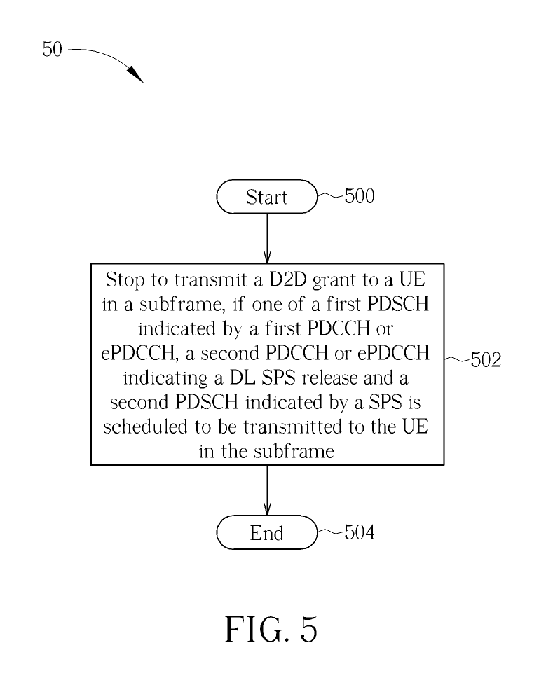

FIG. 5 is a flowchart of a process 50 according to an example of the present invention. The process 50 may be utilized in the network 100 shown in FIG. 1, to handle a D2D communication. The process 50 may be compiled into the program code 214 and includes the following steps:
Step 500: Start.
Step 502: Stop to transmit a D2D grant to a UE in a subframe, if one of a first PDSCH indicated by a first PDCCH or ePDCCH, a second PDCCH or ePDCCH indicating a DL SPS release and a second PDSCH indicated by a SPS is scheduled to be transmitted to the UE in the subframe.
Step 504: End.

According to the process 50, the network 100 may stop to transmit a D2D grant to a UE (e.g., the UE 102 or the UE 104) in a subframe, if one of a first PDSCH indicated by a first PDCCH or ePDCCH, a second PDCCH or ePDCCH indicating a DL SPS release and a second PDSCH indicated by a SPS is scheduled to be transmitted to the UE in the subframe. That is, the problem that the UE may not have sufficient resource for transmitting acknowledgements of the received signals is solved by the network 100. The UE may not need to perform the selection of the signals for acknowledgement (e.g., according to the process 40), because the network 100 does not transmit the D2D grant with other signals in the same subframe. Thus, the D2D grant received in the subframe can be acknowledged properly.

It should be noted that an acknowledgement in the previous examples may be a positive acknowledgement (ACK) or a negative acknowledgement (NACK). A resource in the previous examples may be a time resource (e.g., subframe), a frequency resource (e.g., subcarrier), or a time-frequency resource (e.g., resource block). A UE may need to perform a blind decoding on a DL control channel to obtain a D2D grant, wherein the D2D grant may be configured with a conventional DCI format (e.g. , DCI format 0) or a new DCI format. The UE may determine whether it owns the D2D grant according to a D2D Radio Network Temporary Identifier (D2D-RNTI) associated with the UE. The UE may determine that it owns the D2D grant, if the UE detects its D2D-RNTI in the DL control channel carrying the D2D grant. The DL control channel may be a PDCCH or an ePDCCH.

Those skilled in the art should readily make combinations, modifications and/or alterations on the abovementioned description and examples. The abovementioned description, steps and/or processes including suggested steps can be realized by means that could be hardware, software, firmware (known as a combination of a hardware device and computer instructions and data that reside as read-only software on the hardware device), an electronic system, or combination thereof. An example of the means may be the communication device 20.

Examples of the hardware may include analog circuit(s), digital circuit (s) and/or mixed circuit(s). For example, the hardware may include ASIC(s), field programmable gate array(s) (FPGA(s)), programmable logic device(s), coupled hardware components or combination thereof. In another example, the hardware may include general-purpose processor(s), microprocessor(s), controller(s), digital signal processor(s) (DSP(s)) or combination thereof.

Examples of the software may include set(s) of codes, set(s) of instructions and/or set(s) of functions retained (e.g., stored) in a storage unit, e.g., a computer-readable medium. The computer-readable medium may include SIM, ROM, flash memory, RAM, CD-ROM/DVD-ROM/BD-ROM, magnetic tape, hard disk, optical data storage device, non-volatile storage unit, or combination thereof. The computer-readable medium (e.g., storage unit) may be coupled to at least one processor internally (e.g., integrated) or externally (e.g., separated). The at least one processor which may include one or more modules may (e.g., be configured to) execute the software in the computer-readable medium. The set(s) of codes, the set(s) of instructions and/or the set(s) of functions may cause the at least one processor, the module(s), the hardware and/or the electronic system to perform the related steps.

Examples of the electronic system may include a system on chip (SoC), system in package (SiP), a computer on module (CoM), a computer program product, an apparatus, a mobile phone, a laptop, a tablet computer, an electronic book or a portable computer system, and the communication device 20.

To sum up, the present invention provides a method for handling the feedback of the D2D grant. Performance of the D2D communication is improved due to correct knowledge regarding the reception of the D2D grant. In addition, the signals received in the same subframe can be acknowledged properly, when the resource is not sufficient for responding to all of the signals received in the same subframe.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device for handling a device-to-device (D2D) communication, comprising:
a storage unit for storing instructions of:
receiving a D2D grant from a network in a first subframe; and
transmitting an acknowledgement in response to the D2D grant to the network in a second subframe; and
a processing means, coupled to the storage unit, configured to execute the instructions stored in the storage unit.

2. The communication device of claim 1, wherein the second subframe is determined according to a time-division duplexing (TDD) configuration of the communication device.

3. The communication device of claim 1, wherein a time difference between the first subframe and the second subframe is a fixed value.

4. The communication device of claim 1, wherein the acknowledgement is transmitted on a physical uplink (UL) control channel (PUCCH) of the second subframe.

5. The communication device of claim 4, wherein the acknowledgement is transmitted on the PUCCH, if a data transmission is not performed on a physical UL shared channel (PUSCH) of the second subframe.

6. The communication device of claim 4, wherein a PUCCH resource for transmitting the acknowledgement is determined according to a control channel element (CCE) of a downlink (DL) control channel for transmitting the D2D grant.

7. The communication device of claim 4, wherein a PUCCH resource for transmitting the acknowledgement is determined according to at least one of a higher layer signaling and the D2D grant.

8. The communication device of claim 1, wherein the acknowledgement is transmitted on a PUSCH of the second subframe.

9. The communication device of claim 8, wherein the acknowledgement is transmitted on the PUSCH, if a data transmission is performed on the PUSCH.

10. The communication device of claim 1, wherein the instructions further comprise:
transmitting another acknowledgement in response to a PDSCH to the network in the second subframe.

11. The communication device of claim 10, wherein the PDSCH is indicated by a PDCCH or an enhanced PDCCH (ePDCCH), or is indicated by a semi-persistent scheduling (SPS).

12. The communication device of claim 1, wherein the instructions further comprise:
transmitting another acknowledgement in response to a PDCCH or ePDCCH to the network in the second subframe, wherein the PDCCH or ePDCCH indicates a DL SPS release.

13. A communication device for handling a device-to-device (D2D) communication, comprising:
a storage unit for storing instructions of:
receiving at least one of a first physical downlink (DL) shared channel (PDSCH) indicated by a first physical DL control channel (PDCCH) or enhanced PDCCH (ePDCCH), a second PDCCH or ePDCCH indicating a DL semi-persistent scheduling (SPS) release, a second PDSCH indicated by a SPS and a D2D grant in a first subframe; and
transmitting at least one acknowledgement in response to a set of the at least one of the first PDSCH, the second PDCCH or ePDCCH, the second PDSCH and the D2D grant to the network in a second subframe according to at least one priority of the set of the at least one of the first PDSCH, the second PDCCH or ePDCCH, the second PDSCH and the D2D grant; and
a processing means, coupled to the storage unit, configured to execute the instructions stored in the storage unit.

14. The communication device of claim 13, wherein a plurality of priorities of the at least one of the first PDSCH, the second PDCCH or ePDCCH, the second PDSCH and the D2D grant from high to low are the priority of the first PDSCH, the priority of the second PDCCH or ePDCCH, the priority of the second PDSCH and the priority of the D2D grant.

15. A communication device for handling a device-to-device (D2D) communication, comprising:
a storage unit for storing instructions of:
stopping to transmit a D2D grant to a D2D device in a subframe, if one of a first physical downlink (DL) shared channel (PDSCH) indicated by a first physical DL control channel (PDCCH) or enhanced PDCCH (ePDCCH), a second PDCCH or ePDCCH indicating a DL semi-persistent scheduling (SPS) release and a second PDSCH indicated by a SPS is scheduled to be transmitted to the D2D device in the subframe; and
a processing means, coupled to the storage unit, configured to execute the instructions stored in the storage unit.
